(19) United States
(12) Patent Application Publication
(10) Pub. No.: US 2010/0212225 A1
(43) Pub. Date: Aug. 26, 2010

(54) Nutrient and water-dispensing system for watering and feeding of plants

(75) Inventor: Wilson A. Felknor, Lenoir City, TN (US)

Correspondence Address: MICHAEL E. McKEE;Attorney at Law, 804 Swaps Lane, Knoxville, TN, 37923, US

(73) Assignee: Felknor Ventures LLC.

(21) Appl. No.: 12/590,431

(22) Filed: Nov. 7, 2009

Related U.S. Application Data
(63) Continuation of application No. 12/380,317, filed on Feb. 26, 2009.

(51) Int. Cl. A01G 25/02; B67D 7/06

(52) U.S. Cl. 47/79; 222/145.1

(57) ABSTRACT

A nutrient-holding and flow control system (20) for connection in-line with the flow of water to a plant includes a receptacle (50) having an interior (101) into which nutrients (103) can be positioned and a dispensing head (60) including a substantially circular conduit ring (74) having at least one hose section (82 or 84) having perforated sidewalls (86) through which water and dissolved nutrients are permitted to seep. An intermediate conduit arrangement (80) is joined intermediate the receptacle and the conduit ring for conducting water and dissolved nutrients from the receptacle into the conduit ring at multiple locations thereabout which are disposed at regular spaced intervals around the conduit ring. In addition, a flow controller (52) is associated with the receptacle for permitting a user to shut off or adjust the flow rate of water through the receptacle.

This is a continuation of application Ser. No. 12/380,317, filed Feb. 26, 2009 and entitled NUTRIENT-HOLDING AND FLOW CONTROL SYSTEM FOR IN-LINE CONNECTION WITH WATER FLOW TO PLANTS OR PLANTERS, and the disclosure of which is incorporated herein by reference.

### BACKGROUND OF THE INVENTION

This invention relates generally to gardening accessories and relates, more particularly, to means and methods with which fertilizer and other nutrients are delivered to a plant for growth and with which the flow rate of water to the plant can be controlled.

During the growth of a plant in a controlled environment, such as in a greenhouse or planter, water and plant nutrients are delivered to the plant to keep the plant vital and growing. For this purpose, a water line, such as a garden hose, can be used to conduct water from a source, such as water faucet, to the plant, and nutrients are often delivered manually to an area of the soil adjacent the plant.

It would be desirable to provide a means by which plant fertilizer or other nutrients can be delivered to the plant as water is also delivered to the plant.

Accordingly, it is an object of the present invention to provide a new and improved system enabling plant nutrients to be delivered to the plant when water is delivered to the plant so that both water and nutrients are delivered to the plant simultaneously.

Another object of the present invention is to provide such a system embodying a soaker hose for dispensing nutrients and water relatively evenly over a targeted area adjacent a plant or plants to be fed.

Still another object of the present invention is to provide such a system which is connectable to a water supply conducted from a source and for delivering nutrients to the plant at a controlled, or metered, rate.

Yet another object is to provide such a system enabling a user to make adjustments to the flow of water to the plant without requiring that such adjustments be made to the water flow at the source, such as at a water faucet.

A further object of the present invention is to provide such a system which is uncomplicated in structure, yet effective in operation.

### SUMMARY OF THE INVENTION

This invention resides in a nutrient and water-dispensing system through which water and nutrients are delivered to a plant.

The system includes a receptacle having an interior into which water-soluble nutrients can be placed and including an inlet port into which water is permitted to flow into the interior of the receptacle from a source and an outlet port through which water and dissolved nutrients are permitted to exit the interior of the receptacle for delivery of water and dissolved nutrients to a plant. The system also includes a dispensing head connected to the outlet port of the receptacle for distributing water and nutrients which exit the receptacle over a target area adjacent the plant. The dispensing head includes a) a conduit ring including at least one section having perforated sidewalls through which water and dissolved nutrients are permitted to seep and b) an intermediate conduit arrangement joined intermediate the outlet port of the receptacle and the conduit ring for conducting water and dissolved nutrients from the receptacle into the conduit ring at multiple locations therearound which are disposed at spaced intervals around the conduit ring. With the intermediate conduit arrangement joined between the outlet port of the receptacle in such a manner, water and dissolved nutrients which exit the outlet port of the receptacle flow in sequence through the intermediate conduit arrangement and then through the conduit ring before being distributed over the target area through the sidewalls of the at least one section of the conduit ring.

### BRIEF DESCRIPTION OF THE DRAWINGS

FIG. 1 is a side elevational view illustrating schematically a nutrient and water-dispensing system for delivering water and nutrients to a hanging planter.

FIG. 2 is a perspective view of the nutrient and water-dispensing system of FIG. 1 and a fragment of the planter of FIG. 1, shown with the top removed from the container portion thereof.

FIG. 3 is a perspective view of some of the components of the nutrient and water-dispensing system illustrated in FIG. 1, shown exploded.

FIG. 4 is a perspective view of the receptacle of the components illustrated in FIG. 3, shown exploded.

FIG. 5 is a plan view of a fragment of the nutrient and water-dispensing system illustrated in FIG. 1, shown exploded.

FIG. 5a is an elevational view of an exemplary tee-connector utilized in the system of the present invention.

FIG. 6 is a perspective view of an alternative planter having multiple levels within which plants can be grown.

FIG. 7 is a perspective view illustrating schematically an alternative embodiment of a nutrient and water-dispensing system which can be used to deliver nutrients and water to the multiple levels of the planter illustrated in FIG. 6.

### DETAILED DESCRIPTION OF ILLUSTRATIVE EMBODIMENTS

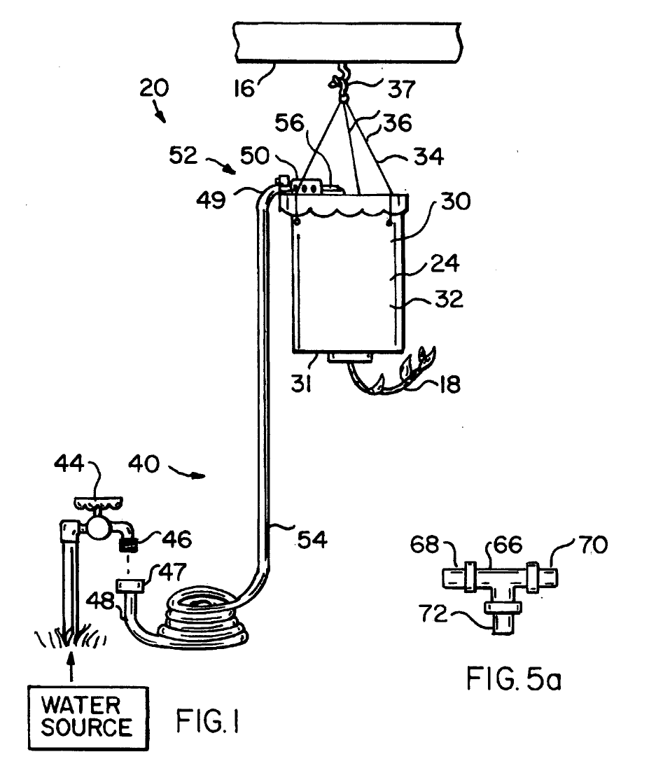

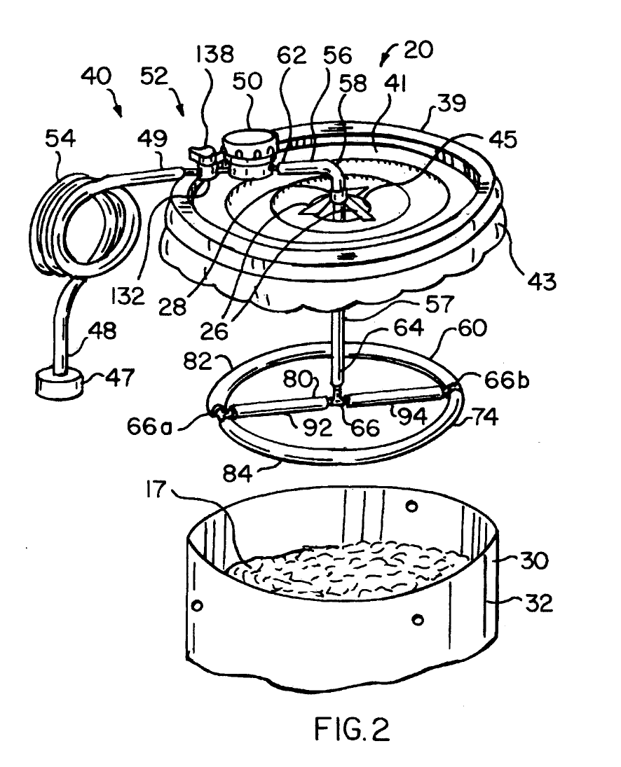

Turning now to the drawings in greater detail and considering first FIGS. 1 and 2, there is illustrated a nutrient and water-dispensing system, generally indicated 20, which embodies features of the present invention and which can be used to deliver water and nutrients to a hanging planter 24.

The hanging planter 24 includes an open-topped container 30 having a bottom 31 and cylindrical sidewalls 32 for holding dirt or potting soil 17 and within which a plant 18 is transplanted for growth out the bottom thereof. A hanger system 34 includes a plurality of cables 36 which are securable at one (i.e. the lower) end thereof to the container sidewalls 32 adjacent the upper edges thereof. The other (i.e. the upper) ends of the cables 36 are gathered at a hook 37 for suspending the planter 24 from an elevated structure 16.

Also associated with the container 30 is a cover, or top member 39 (best shown in FIG. 2), having a central portion 41 which is platen-like in form and which has peripheral edges 43 which are shaped to overhang the upper edges of the container 30 when the top member 39 is positioned so as to cover the open top of the container 30. Defined within the center of the top member 39 is an opening 45 through which a conduit (described herein) of the depicted system 20 extends for the purpose of conducting water or nutrients into the interior of the container 30. Also included with the top member 39 is an arrangement of struts 26 which are joined at one end (i.e. the lower end as viewed in FIG. 2) to the central portion 41 about the central opening 45 and converge toward one another at the opposite ends to support a ring 28. As will be described herein, the ring 28 is used to help join the depicted system 20 to the planter 24.

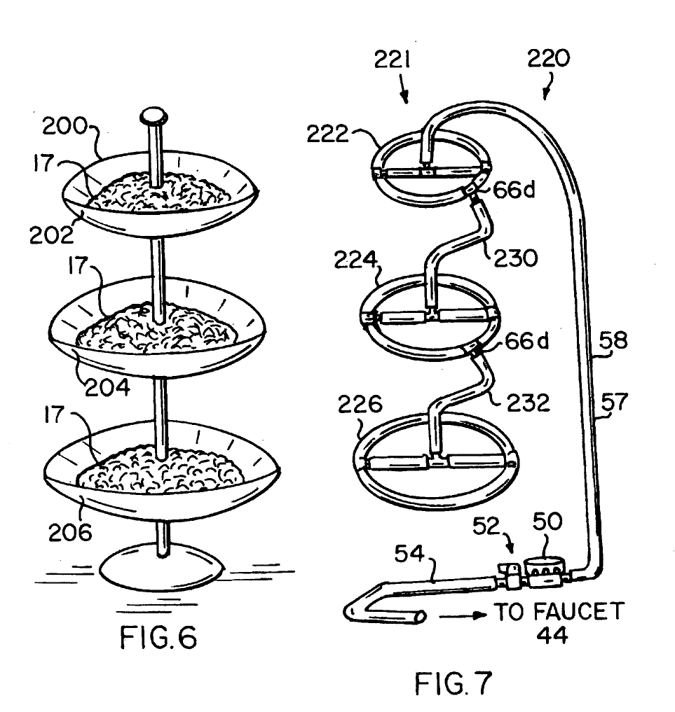

It will be understood that the depicted planter 24 is intended to provide one example of a class of planters with which the nutrient and water-dispensing system 20 embodying features of the present invention can be utilized. A planter 24 can, for example, take the form of a common planter in which a plant can be grown out the top thereof, a container having a side port (or ports) through which plants can be grown out the sides thereof, or a stand-supported planter (as is illustrated in FIG. 6) having multiple levels for plant growth. Accordingly, the principles of the present invention can be variously applied.

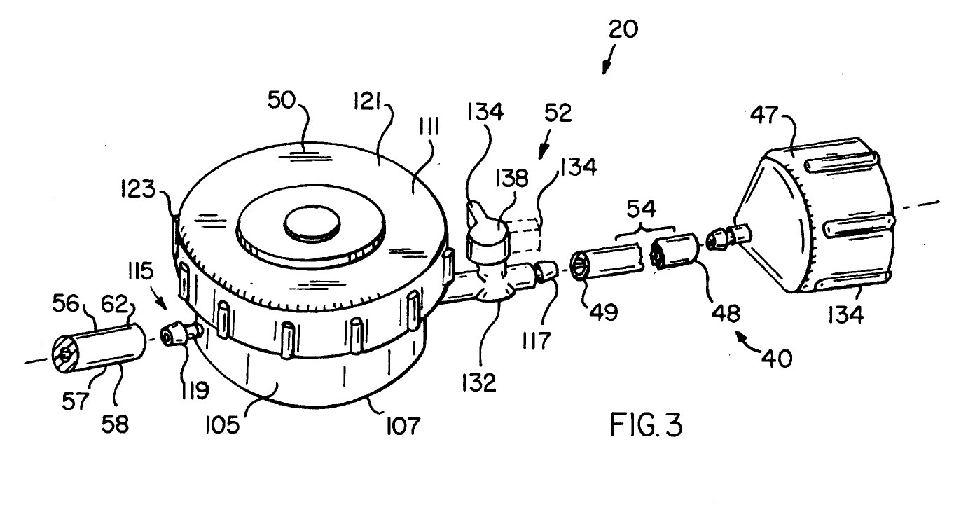

With reference still to FIGS. 1 and 2, the nutrient and water-dispensing system 20 includes a network, indicated 40, of conduits, described herein for delivery of water to the planter 24 from a source 42 which in the depicted FIG. 1 example, is accessible through a water faucet 44 having an externally-threaded spout 46. In addition, the system 22 includes a nutrient-holding receptacle, or receptacle means, 50 into which water-soluble nutrients are placed and through which the water which is conducted by the conduit network 40 toward the planter 24 is passed so that as the water passes through the receptacle 50, the nutrients become dissolved within the water and are subsequently carried by the water to the planter 24. The system 20 also includes a flow controller, or flow control means, generally indicated 52, which is disposed on the upstream side of the receptacle 50 for controlling the rate of flow of water into the receptacle 50, and the receptacle 50 and the flow control means 52 are directly coupled (as is best shown in FIG. 3) so as to be in flow communication with one another.

With reference to FIGS. 1-3, the conduit network 40 of the depicted system 20 includes an upstream conduit portion 54 (i.e. connected upstream of the receptacle 50) having two opposite ends 48 and 49 and which is joined at its end 49 to the flow control means 52 and is connectable at its other end 48 to the water faucet 44. For connection to a water faucet 44, there is attached to the conduit end 48 an internally-threaded connector 47 at its end 49 enabling the conduit end 49 to be threadably joined to the spout 46 of the water faucet 44. In the system 20, the upstream conduit portion 54 is relatively lengthy (e.g. preferably greater than twenty feet) to enable water to be delivered to a planter 24 which may be sited relatively far from a water faucet 44. If necessary, however, a common garden hose (not shown) can be joined to the conduit end 48 (by way of the connector 47) for adding additional length to the conduit portion 54 (and thereby enabling a faucet to be reached which is situated at a distance from a planter which is greater than the length of the conduit portion 54).

The conduit network 40 also includes a downstream conduit portion 56 which is joined to the nutrient-holding receptacle 50 so as to extend downstream of the receptacle 50. The depicted conduit portion 56 includes a dispensing head, or means 60, through which water and dissolved nutrients which exit the receptacle 50 are dispensed over a target area and an intermediate conduit arrangement 57 which extends between the nutrient-holding receptacle 50 and the dispensing head 60.

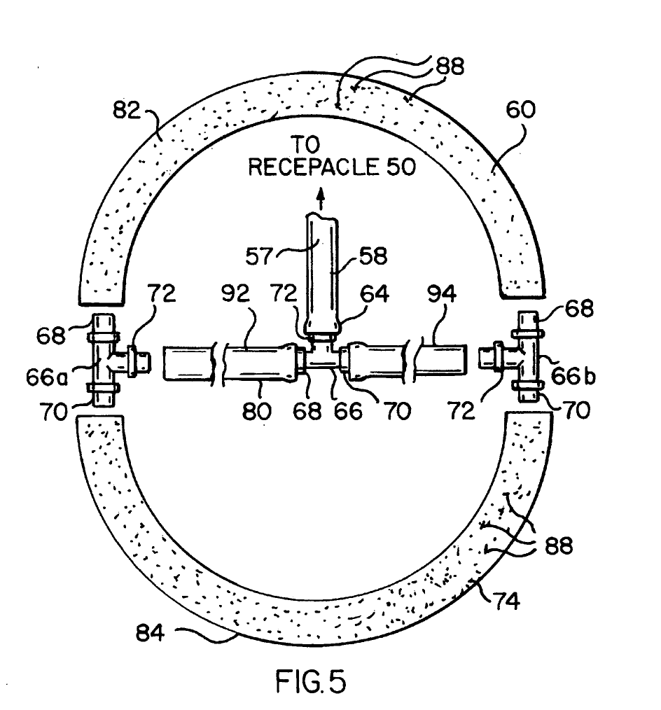

The intermediate conduit arrangement 57 includes a hose section 58 having an end 62 which is joined directly to the receptacle 50 and a linear arrangement 80 of conduits for joining the conduit ring 74 to the opposite end, indicated 64, of the hose section 58. For purposes of connecting the end 64 of the hose section 58 to the linear conduit arrangement 80, the system 20 includes a tee-connector 66 (best shown in FIG. 5a) having a pair of oppositely-extending arms 68 and 70 and a leg 72 which is joined to so as to extend at a right angle with respect to the arms 68, 70. As will be apparent herein, additional tee-connectors (i.e. those indicated 66a and 66b in FIG. 5) which are comparable in shape to that of the connector 66 are used to join the linear conduit arrangement 80 to the conduit ring 74.

As best shown in FIG. 5, the dispensing head 60 includes a substantially circular conduit ring 74 through which the water and dissolved nutrients are deposited upon a targeted area of the potting soil 17, and the linear conduit arrangement 80 which is joined in flow communication between the hose section 58 and the conduit ring 74 so that water and dissolved nutrients which exit the receptacle means 50 flow in sequence through the hose section 58, then through the linear conduit arrangement 80 and then through the conduit ring 74. The linear conduit arrangement 80 includes a pair of conduits 92, 94 which are connected to one another in an end-to-end relationship by way of the tee-connector 66, introduced earlier, and the opposite ends of the conduit sections 80 are joined to the connectors 66a and 66b to join these ends in flow communication with the conduit ring 74. More specifically, an end of each conduit section 92, 94 is fitted about corresponding arm 68 or 70, and the end 64 of the hose section 58 opposite the receptacle 50 is fitted about the leg 72 of the tee-connector 66 so that the conduits 92, 94 and hose section 58 are joined in flow communication with one another.

Within the depicted conduit ring 74, there are provided two conduit sections 82, 84 of substantially equal length and which are arranged in a circular form and which are joined to one another at the ends thereof by way of a pair of tee-connectors 66a, 66b. More specifically, each end of the one conduct section 82 is joined to one arm 68 of the tee-connector 66a or 66b, and one end of the other conduit section 84 is joined to the other arm 70 of the tee-connector 66a or 66b so that the conduit ring 74 assumes its circular (e.g. FIG. 5) form.

It is a feature of the depicted system 20 that each conduit section 82 or 84 includes a series of perforations 88 along the length thereof through which water or dissolved nutrients which are directed into the conduit 82 or 84 are permitted to seep. In this connection, the conduit sections 82 or 84 have sidewalls 86 which extend between its ends, and these sidewalls 86 define perforations 88 which, upon exposure to a pressurized fluid (above a threshold level) contained within the conduit sections 82 or 84, permit the passage of the fluid therethrough. Thus, when water and dissolved nutrients are directed into the conduit sections 82 or 84 of the dispensing head 60 by way of the receptacle 50, the water and dissolved nutrients are permitted to seep (i.e. be discharged from) the conduit sections 82, 84 by way of the perforations 88. An example of a conduit which has been found to be well-suited for use as either of the conduit sections 82, 84 is in the form of a hose (i.e. a flexible tube constructed of an elastomeric material) commercially available under the trade designation Soaker Hose from Aquarius Manufacturing Ltd of Lancashire, England.

It also follows from the foregoing that water is delivered to the conduit ring 74 at locations which are spaced (and preferably substantially regularly spaced) around the conduit ring 74 and, more specifically, at diametrically-opposed locations thereon. It is believed that by delivering water to multiple locations which are spaced around the conduit ring 74, the water and dissolved nutrients which are carried by the water from the receptacle 50 are discharged relatively evenly over the length of the conduit sections 82, 84. In other words, by providing multiple, spaced locations about the conduit ring 74 at which the internal water pressure within the conduit sections 82, 84 is the highest, the water flows into (and through) the conduit sections 82, 84 from those multiple locations thereabout. In the depicted dispensing head 60 of the depicted embodiment 20, the internal water pressure is at its highest within the tww-connectors 66a and 66b so that the water flows along the sections 82, 84 from the tee-connectors 66a and 66b. Consequently, the distribution of water and dissolved nutrients out through the sidewalls 86 of the conduit sections 82, 84 is believed to be relatively even along the length of the conduit sections 82, 84 and is thereby distinguishable from a situation in which water is delivered to conduit ring at only a single location therearound.

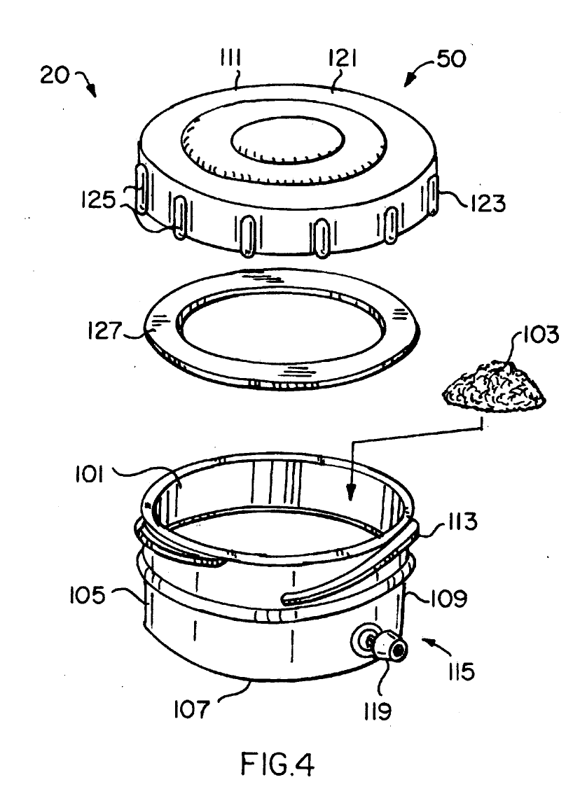

With reference to FIGS. 3 and 4, the nutrient-holding receptacle 50 is somewhat jar-shaped in form and defines an interior 101 adapted to hold an amount of nutrients (such as a water-soluble granular fertilizer 103 illustrated in FIG. 4) for mixing with water directed through the receptacle 50 on its way toward the potting soil 17 (FIG. 1) of the planter 24. To this end, the receptacle 50 includes an open-topped compartment 105 having a planar bottom 107 and cylindrical sidewalls 109 and further includes a removable cap 111. Defined along the sidewalls 109 of the compartment 105 and adjacent the top thereof are external threads 113 which cooperate with the cap 111 to permit the cap 111 to be threadably secured about the compartment 105 and thereby cover the open top thereof or removed from the compartment 105 to provide access to the interior 101 thereof.

Furthermore, there is associated with the receptacle 50 and flow control means 52 port means, generally indicated 115, which accommodates the attachment of a corresponding conduit portion 54 or 58 in-line with the receptacle 50 and flow control means 52 for delivery of a flow of water therethrough. More specifically, the port means 115 includes an inlet port 117 disposed on the upstream side of the flow control means 52 which permits the attachment of the exit end, indicated 49, of the conduit portion 54 to the flow control means 52. In the depicted embodiment 20, the inlet port 117 is sized to be received by the exit end 49 when the exit end 49 is directed endwise over the inlet port 117 to a snug-fitting relationship thereabout.

The port means 115 also includes an outlet port 119 disposed on the side of the compartment 105 opposite the inlet port 117 which permits the attachment of the inlet end, indicated 62, of the hose section 58 (of the conduit arrangement 57) to the receptacle 50. In the depicted system 20, the outlet port 119 is sized to be received by the inlet end 62 as the inlet end 62 is directed endwise onto the outlet port 119 to a snug-fitting relationship thereabout. Furthermore, each of the inlet and outlet ports 117 and 119 is preferably provided with a barbed outer surface, as shown in FIGS. 3 and 4, to enhance the securement between the port and the conduit section connected to the port.

The removable cap 111 of the receptacle 50 includes a platen cover portion 121 and cylindrical sidewalls 123 which extend downwardly (as viewed in FIG. 4) from the cover portion 121. The interior surfaces of the sidewalls 123 are provided with internal threads which cooperate with the external threads 113 (FIG. 4) of the compartment 105 so that the cap 111 can be threadably attached to the compartment 105 by screwing the cap 111 about the compartment 105 (to thereby close the open top of the compartment 105) or removed from the compartment 105 by unscrewing the cap from the compartment 105 (to thereby provide access to the interior 101 of the receptacle 50). As is the case with the compartment 105, the cap 111 can also be formed, or molded, out of plastic material; and if desired, the exterior surface of the cap sidewalls 123 can be provided with axially-extending protuberances 125 which are regularly spaced around the cap 111 to increase the ease with which the cap 111 can be gripped.

To ensure a tight seal between the surfaces of the cap 111 and the compartment 105, the receptacle 50 preferably includes a flat washer 127 constructed, for example, of elastomeric material which is positionable along the edge of the compartment top so that when the removable cap 111 is tightened about the compartment 105, the washer 127 is tightly sandwiched between the top of the compartment 105 and the underside of the cover portion 121.

It follows that the removable cap 111 provides a user with access to the interior 101 of the receptacle 50. For use of the system 20 (and while the flow of water through the receptacle 50 is shut off), the cap 111 is removed from the compartment 105 and then fertilizer 103 or other plant nutrients (which may be in solid or liquid form and, in either case, is water soluble) is placed within the interior 101 of the receptacle 50. The cap 111 is then replaced upon the compartment 105 to cover, and thereby close, the top thereof, and the water flow through the receptacle 50 is turned ON. As water is permitted to be routed into the receptacle 50, the nutrients mix with (i.e. dissolve within) the water flow so that water which subsequently exits the receptacle 50 through the outlet port 119 carries with it the dissolved fertilizer toward the dispensing head 60.

An example of a fertilizer which has been found to be suitable for use as the fertilizer 103 with the system 20 is a water soluble granular fertilizer available under the trade designation Tomato Plant Food from the Scotts Miracle-Gro Company of Marysville, Ohio.

As mentioned above and with reference again to FIGS. 2 and 3, there is associated with the nutrient-holding receptacle 50 flow control means, generally indicated 52, for controlling the flow of water through the receptacle 50. In this connection, the flow control means 52 includes a passageway-defining body 132 formed between the inlet port 117 and the receptacle 50, and there is mounted within the body 132 a flow control valve having an adjustment knob 138 which permits a user to adjust the rate of flow of the water into the receptacle interior 101 by rotating the knob 138 relative to the body 132 to alternative positions. The knob 138 of the flow control means 52 can be molded, or formed, as a separately-identifiable component from that of the body 132; and if desired, the exterior surface of the knob 138 can be provided with an outwardly-extending protuberance 134 to improve the capacity of the knob 138 to be gripped by a user.

The flow control valve 136 of the depicted flow control means 52 is a ball-type, infinitely-variable valve whose position within the body 132 of the flow control means 52 can be adjusted between a fully ON orientation (as is illustrated in phantom in FIG. 3) and a fully OFF position (as is illustrated in solid lines in FIG. 3) so as to provide any desired flow rate between the fully ON condition or fully OFF condition (for providing a flow rate of zero through the valve 136). For example, if it is desired that the flow rate through the valve 136 be about midway between the fully ON and fully OFF conditions, the knob 138 should be moved relative to the valve 136 to a rotational position which is about half-way between its fully ON and fully OFF positions. It can be noted that the knob 138 is rotated relative to the body 132 through only about ninety degrees of angular movement as it is rotated between its fully ON and fully OFF positions. Thus, if it is desired to permit a relatively small, or drip, rate of fluid flow through the valve 136, the knob 138 would be rotated relative to the valve body 132 to a position disposed relatively close to, but not in, the fully OFF position.

Exemplary dimensions of various components of the system 20 are provided here as follows: The outer diameter of the removable cap 100 of the receptacle 50 can be about 2.25 inches; the depth of the cap 100 can be about 1.2 inches; the wall thickness of the cap 100 can be about 0.070 inches; the outer diameter of the compartment 86 of the receptacle 50 can be about 2.125 inches; the depth of the compartment 86 can be about 1.1 inches; each of the conduit portions 54 and 58 can be provided by a plastic hose having an outer diameter of 0.25 inches; the ports 117 and 119 (with the barbed connectors associated therewith) are sized to be snugly accepted by the conduit portions having the 0.5 inch outer diameter; the length of the hose section 58 is about 8.0 inches; the outer diameter of each conduit section 82 or 84 is about 0.25 inches; and the diameter of conduit ring 74 is about 4.75 inches.

As mentioned earlier and with reference again to FIG. 2, ring 28 (which is depicted as being joined to the remainder of the top member 39 so as to be disposed above the opening 45) can be used to join the system 20 to the planter 24. More specifically, the hose section 58 can be routed through the ring 28 (before assembly of the conduit network 40) so that upon assembly of the conduit network 40, the ring 28 is disposed between the receptacle 50 and the conduit ring 74. With the system 20 connected to the planter 24 in such a manner, the removal of the conduit ring 74 from the interior of the planter 24 (to provide access to the planter interior) can be effected by removal of the top member 39 from the container 30, and replacement of the conduit ring 74 into the container interior can be effected by replacing the top member 39 over so as to cover the open top of the container 30.

It follows from the foregoing that a water and nutrient-delivery system 20 has been described with which water and nutrients can be delivered to a planter 24. Furthermore, there is incorporated within the system 20 a nutrient-holding and flow control system 22 including a receptacle 50 into which a user can deposit fertilizer or other plant nutrients for delivery to the planter 24 with water from a source 42 and a flow control mean 52 through which the user can control the rate of flow of water through the receptacle 50. Thus, the receptacle 50 and flow control means 52 provides a convenient and uncomplicated means by which water and fertilizer or other nutrients can be delivered simultaneously to the container 30 of the planter 24 at a metered rate and allows a user to control the flow rate of water through the receptacle means 50 and into the container 30 without having to control the water flow at the faucet 44.

It is envisioned that the aforedescribed system 20 is particularly well-suited for delivering liquid fertilizer (which is poured into the receptacle means 50) to the container 30 at a relatively slow rate, and provides a user with an alternative to known, more-costly greenhouse watering and feeding drip systems. In other words, because the system 20 need not involve the relatively sophisticated equipment commonly associated with greenhouse watering and feeding drip systems, such as can involve timers, nutrient barrels, water lines and pumps, the system 20 is advantageous in this respect. Furthermore, the system 20 is relatively easy to use in that fertilizer can be deposited or poured within the receptacle means within a few seconds, uses water pressure to deliver the nutrients directly to the plant, and because the nutrients are delivered to a targeted area (by way of the conduit ring 74), reduces nutrient waste.

It will be understood that numerous modifications and substitutions can be had to the aforedescribed embodiment 22 without departing from the spirit of the invention. For example, although the system 20 has been shown and described as including a single conduit ring 74 for dispensing water and nutrients relatively evenly over a single target area, such as atop the potting soil 17 of the planter 24, a system which embodies the features of the present invention can be used for delivering water and dissolved nutrients to multiple target areas. For example, there is illustrated in FIG. 6 a planter 200 having multiple levels 202, 204 and 206 for holding potting soil 17 for growing desired plants, and there is illustrated in FIG. 7 an exemplary water and nutrient-dispensing system 220 having a dispensing head 221 including multiple conduit rings 222, 224 and 226 for delivering water and nutrients to each of the three levels 202, 204 and 206 of the planter 200. The conduit rings 222, 224, 226 are joined in flow communication with one another with conduit sections 230, 232 and tee-connectors 66d, best shown in FIG. 7. Other components of the system 200 which are identical to those of the system 20 (although not necessarily in length) are accordingly given the same reference numerals. It follows that by placing each conduit ring 222, 224 or 226 atop the potting soil 17 positioned in a corresponding level 202, 204 or 206 of the planter 200 and placing water-soluble nutrients within the receptacle 50, water which is subsequently permitted to flow through the receptacle 50 carries water and dissolved nutrients to the levels 202, 204 and 206 of the planter 200 where the water and dissolved nutrients are dispensed atop the potting soil 17 in all three growing levels 202, 204 and 206 by way of the dispensing heads 220, 222 and 224.

Furthermore, although the receptacle 50 of the aforedescribed system 20 has been shown and described as including a screw-on cap 111, a receptacle embodying features of the present invention can include a snap-on cap which is capable of being attached to the remainder of the receptacle in a snap-fitting relationship therewith.

It will also be understood that the invention described herein can be embodied within a dispensing system (e.g. like that of the embodiment 20 described and shown herein) standing alone or within a dispensing system (e.g. like that of the embodiment 20 described and shown herein) in combination with a planter to which the water and nutrients and desired to be delivered by way of the dispensing system.

Accordingly, the aforedescribed embodiment 20 is intended for the purpose of illustration and not as limitation.

1. A nutrient and water-dispensing system through which water and nutrients are delivered to a plant, the system comprising:
a receptacle having an interior into which water-soluble nutrients can be placed and including an inlet port into which water is permitted to flow into the interior of the receptacle from a source and an outlet port through which water and dissolved nutrients are permitted to exit the interior of the receptacle for delivery of water and dissolved nutrients to a plant;
a dispensing head connected to the outlet port of the receptacle for distributing water and nutrients which exit the receptacle over a target area adjacent the plant, the dispensing head including:
a) a conduit ring including at least one section having perforated sidewalls through which water and dissolved nutrients are permitted to seep; and
b) an intermediate conduit arrangement joined intermediate the outlet port of the receptacle and the conduit ring for conducting water and dissolved nutrients from the receptacle into the conduit ring at multiple locations therearound which are disposed at spaced intervals around the conduit ring so that water and dissolved nutrients which exit the outlet port of the receptacle flow in sequence through the intermediate conduit arrangement and then through the conduit ring before being distributed over the target area through the sidewalls of the at least one section of the conduit ring.

2. The system as defined in claim 1 further including a flow controller which permits a user to alter the flow rate of water through the receptacle.

3. The system as defined in claim 1 further including a flow controller associated with the inlet port of the receptacle which permits a user to shut off the flow of water to the receptacle and thereafter place an amount of water-soluble nutrients in the receptacle for subsequent delivery to the plant.

4. The system as defined in claim 3 wherein the flow controller includes a manually adjustable valve which is in flow communication with the interior of the receptacle to permit a user to control the flow of water through the receptacle, and wherein the flow controller is an infinitely-variable valve including a body defining a passageway which is connected in flow communication with the interior of the receptacle, and the manually adjustable valve includes a knob which can be rotated relative to the body of the flow controller through about ninety degrees of angular movement between fully ON and fully OFF positions.

5. The system as defined in claim 1 wherein the conduit ring includes multiple sections having perforated sidewalls wherein each of the multiple sections forms an arc of the conduit ring and the multiple sections are joined in an end-to-end relationship with one another with a tee-connector disposed between each adjacent pair of the multiple sections.

6. The system as defined in claim 5 wherein each tee-connector includes two arms and a leg, and each of the multiple sections in an adjacent pair of the multiple sections is connected to an arm of a tee-connector, and the intermediate conduit arrangement is connected in flow communication with the conduit ring by way of the legs of the tee-connectors.

7. The system as defined in claim 1 wherein the at least one section of hose has an outer diameter of about 0.25 inches.

8. The system as defined in claim 1 wherein the receptacle includes an open-topped compartment portion into which the nutrients are positionable and a removable cap for selectively opening and closing the open top of the compartment portion.

9. The system as defined in claim 1 further comprising an upstream conduit section having two opposite ends and which is connectable at one end to a water faucet and which is connected at the other one end to the inlet port of the receptacle for delivery of water to the receptacle from a water faucet.

10. The system as defined in claim 1 wherein the multiple spaced locations around the conduit ring into which water and dissolved nutrients are conducted are substantially regularly spaced around the conduit ring.

11. The system as defined in claim 1 in combination with a amount of water-soluble nutrients placed within the receptacle.

12. A nutrient and water-dispensing system through which water and nutrients are delivered to a plant, the system comprising:
a receptacle having an interior into which water-soluble nutrients can be placed and including an inlet port into which water is permitted to flow into the interior of the receptacle from a source and an outlet port through which water and dissolved nutrients are permitted to exit the interior of the receptacle for delivery of water and dissolved nutrients to a plant;
a flow controller associated with the receptacle which permits a user to alter the flow rate of water through the receptacle; and
a dispensing head connected to the outlet port of the receptacle for distributing water and nutrients which exit the receptacle over a target area adjacent the plant, the dispensing head including:
a) a conduit ring including at least one section having perforated sidewalls through which water and dissolved nutrients are permitted to seep;
b) one conduit section joined in flow communication with the conduit ring at multiple locations spaced about the conduit ring; and
c) an intermediate conduit section having two opposite ends and which is joined in flow communication at one of its ends with said one conduit section and which is joined in flow communication at the other of its ends with the outlet port of the receptacle so that water and dissolved nutrients which exit the outlet port of the receptacle flow in sequence through said intermediate conduit section, through said one conduit section and then through the conduit ring before being distributed over the target area through the sidewalls of the at least one section of the conduit ring.

13. The system as defined in claim 12 wherein the flow controller is associated with the inlet port of the receptacle which permits a user to shut off the flow of water to the receptacle and place an amount of water-soluble nutrients in the receptacle for subsequent delivery to the plant.

14. The system as defined in claim 13 wherein the flow controller includes a manually adjustable valve which is in flow communication with the interior of the receptacle to permit a user to control the flow of water through the receptacle, and wherein the flow controller is an infinitely-variable valve including a body defining a passageway which is connected in flow communication with the interior of the receptacle, and the manually adjustable valve includes a knob which can be rotated relative to the body of the flow controller through about ninety degrees of angular movement between fully ON and fully OFF positions.

15. The system as defined in claim 12 wherein said one conduit section is joined in flow communication with the conduit ring at diametrically-disposed locations about the conduit ring and the conduit ring includes two sections having perforated sidewalls wherein each section forms one-half of the conduit ring and the two hose sections are joined to one another at one end with a first tee-connector and are joined to one another at the other end with a second tee-connector.

16. The system as defined in claim 15 wherein each of the first and second tee-connector includes two arms and a leg, and the two sections of the conduit ring are connected to one another at one end thereof by way of the arms of the first tee-connector, and the two sections of hose are connected to one another at the other end thereof by way of the arms of the second tee-connector, and said one conduit is connected in flow communication with the conduit ring by way of the legs of the tee-connectors.

17. The system as defined in claim 15 further comprising an upstream conduit section having two opposite ends and which is connectable at one end to a water faucet and which is connected at the other one end to the inlet port of the receptacle for delivery of water to the receptacle from a water faucet.

18. The system as defined in claim 12 wherein the multiple spaced locations around the conduit ring into which water and dissolved nutrients are conducted are substantially regularly spaced around the conduit ring.

19. The system as defined in claim 12 in combination with a amount of water-soluble nutrients placed within the receptacle.

20. A nutrient and water-dispensing system through which water and fertilizer are delivered to a target area for growth of a plant, the system comprising:
an amount of water-soluble fertilizer;
a receptacle having an interior for containing the amount of water-soluble fertilizer and including an inlet port into which water is permitted to flow into the interior of the receptacle from a source and an outlet port through which water and dissolved fertilizer are permitted to exit the interior of the receptacle for delivery of water and dissolved nutrients to a plant;
a flow controller associated with the inlet of the receptacle which permits a user to alter the flow rate of water through the receptacle and which permits a user to shut off the flow of water through the receptacle; and
a dispensing head connected to the outlet port of the receptacle for distributing water and nutrients which exit the receptacle over a target area adjacent the plant, the dispensing head including:
a) a conduit ring including at least one section having perforated sidewalls through which water and dissolved nutrients are permitted to seep; and
b) an intermediate conduit arrangement joined intermediate the outlet port of the receptacle and the conduit ring for conducting water and dissolved fertilizer from the receptacle into the conduit ring at multiple locations therearound which are disposed at spaced intervals around the conduit ring so that water and dissolved nutrients which exit the outlet port of the receptacle flow in sequence through said intermediate conduit arrangement and then through the conduit ring before being distributed over the target area through the sidewalls of the at least one section of the conduit ring.

21. The system as defined in claim 20 further comprising an upstream conduit section having two opposite ends and which is connectable at one of its ends to a water faucet and which is connected at the other of its ends to the inlet port of the receptacle for delivery of water to the receptacle from a water faucet.

22. The system as defined in claim 20 wherein the multiple spaced locations around the conduit ring into which water and dissolved nutrients are conducted are substantially regularly spaced around the conduit ring.

23. A planter assembly comprising:
a container within which a plant can be grown; and
a nutrient and water-dispensing system through which water and nutrients are delivered to the container wherein the system includes a receptacle having an interior into which water-soluble nutrients can be placed and including an inlet port into which water is permitted to flow into the interior of the receptacle from a source and an outlet port through which water and dissolved nutrients are permitted to exit the interior of the receptacle for delivery of water and dissolved nutrients into the container; and
wherein the system further includes a dispensing head connected to the outlet port of the receptacle for distributing water and nutrients which exit the receptacle over a target area within the container, and wherein the dispensing head includes:
a) a conduit ring including at least one section having perforated sidewalls through which water and dissolved nutrients are permitted to seep and which is positionable with the container; and
b) an intermediate conduit arrangement joined intermediate the outlet port of the receptacle and the conduit ring for conducting water and dissolved nutrients from the receptacle into the conduit ring at multiple locations spaced therearound so that water and dissolved nutrients which exit the outlet port of the receptacle flow in sequence through the intermediate conduit arrangement and then through the conduit ring before being distributed over the target area within the container through the sidewalls of the at least one section of hose.
